(19) United States
(12) Patent Application Publication
(10) Pub. No.: US 2009/0081515 A1
(43) Pub. Date: Mar. 26, 2009

(54) SUPPORTED CATALYST, METHOD FOR MANUFACTURING SUPPORTED CATALYST, FUEL CELL, AND METHOD FOR MANUFACTURING FUEL CELL

(75) Inventors: Yukihiro Shibata, Fukuoka-ken (JP); Naoya Hayamizu, Kanagawa-ken (JP); Jun Momma, Kanagawa-ken (JP); Hideo Oota, Tokyo (JP)

Correspondence Address: PEARNE & GORDON LLP, 1801 EAST 9TH STREET, SUITE 1200, CLEVELAND, OH, 44114-3108, US

(73) Assignee: KABUSHIKI KAISHA TOSHIBA, Tokyo (JP)

(21) Appl. No.: 12/239,018

(22) Filed: Sep. 26, 2008

(30) Foreign Application Priority Data
Sep. 26, 2007 (JP) 2007-250030

(51) Int. Cl. H01M 8/10; B01J 21/18; H01M 4/88

(52) U.S. Cl. 429/30; 502/439; 502/101

(57) ABSTRACT

A supported catalyst includes: a particulate first carbon material; and a particulate second carbon material supporting a catalyst, having a smaller center particle diameter than the first carbon material, and adsorbed on a surface of the first carbon material.

### CROSS-REFERENCE TO RELATED APPLICATIONS

This application is based upon and claims the benefit of priority from the prior Japanese Patent Application No. 2007-250030, filed on Sep. 26, 2007; the entire contents of which are incorporated herein by reference.

### BACKGROUND OF THE INVENTION

1. Field of the Invention

This invention relates to a supported catalyst, a method for manufacturing a supported catalyst, a fuel cell, and a method for manufacturing a fuel cell.

2. Background Art

With the recent progress of electronics, electronic devices have become smaller, more powerful, and more portable, and cells used therein increasingly need downsizing and higher energy density. In this context, fuel cells, which have high capacity although small and lightweight, are attracting attention. In particular, as compared with fuel cells based on hydrogen gas, the direct methanol fuel cell (DMFC) using methanol as its fuel is free from difficulty in handling hydrogen gas and needs no systems for reforming an organic fuel to produce hydrogen. Thus, DMFC is suitable for downsizing.

Such a direct methanol fuel cell has a fuel electrode (anode), a polymer solid electrolyte membrane, and an air electrode (cathode) provided in this order adjacent to each other to form a membrane electrode assembly. A fuel (methanol) is supplied to the fuel electrode side and reacted in a supported catalyst on the fuel electrode side near the polymer solid electrolyte membrane to produce protons (H⁺) and electrons (e⁻). On the other hand, at a supported catalyst on the air electrode side near the polymer solid electrolyte membrane, protons (H⁺) which have permeated through the polymer solid electrolyte membrane react with electrons (e⁻) conducted to the air electrode side and air (oxygen) to produce water.

Here, improvement of cell characteristics greatly depends on the production of protons (H⁺) and electrons (e⁻) by the reaction at the catalyst on the fuel electrode side and the supply of the protons (H⁺) and electrons (e⁻) to the catalyst on the air electrode side. That is, an important factor is to enhance the migration of protons (H⁺) and electrons (e⁻) at the supported catalyst.

To this end, some catalyst supports having increased proton (H⁺) conductivity are proposed (see JP-T-2005-527957 and JP-A-2005-150002(Kokai)).

However, in the techniques disclosed in JP-T-2005-527957 and JP-A-2005-150002(Kokai), migration enhancement of electrons (e⁻) at the supported catalyst is not considered, and there is a possibility that the power generation efficiency cannot be improved.

### SUMMARY OF THE INVENTION

According to an aspect of the invention, there is provided a supported catalyst including: a particulate first carbon material; and a particulate second carbon material supporting a catalyst, having a smaller center particle diameter than the first carbon material, and adsorbed on a surface of the first carbon material.

According to another aspect of the invention, there is provided a supported catalyst including: a linear first carbon material; and a second carbon material supporting a catalyst and adsorbed on a surface of the first carbon material.

According to another aspect of the invention, there is provided a method for manufacturing a supported catalyst, including: allowing a particulate second carbon material to support a catalyst; modifying a surface of a first carbon material with a substituent group capable of supplying a proton by dissociation, the first carbon material having a larger center particle diameter than the second carbon material; and allowing the surface of the first carbon material to adsorb the second carbon material.

According to another aspect of the invention, there is provided a method for manufacturing a supported catalyst, including: allowing a second carbon material to support a catalyst; modifying a surface of a linear first carbon material with a substituent group capable of supplying a proton by dissociation; and allowing the surface of the first carbon material to adsorb the second carbon material.

According to another aspect of the invention, there is provided a fuel cell including: a fuel electrode having a supported catalyst; an air electrode having a supported catalyst; and a polymer solid electrolyte membrane provided between the fuel electrode and the air electrode, at least one of the supported catalysts of the fuel electrode and the air electrode is the supported catalyst including: a particulate first carbon material; and a particulate second carbon material supporting a catalyst, having a smaller center particle diameter than the first carbon material, and adsorbed on a surface of the first carbon material.

According to another aspect of the invention, there is provided a method for manufacturing a fuel cell, the fuel cell including a fuel electrode having a supported catalyst, an air electrode having a supported catalyst, and a polymer solid electrolyte membrane provided between the fuel electrode and the air electrode, the method including: manufacturing at least one of the supported catalysts of the fuel electrode and the air electrode by the method for manufacturing a supported catalyst including: allowing a particulate second carbon material to support a catalyst; modifying a surface of a first carbon material with a substituent group capable of supplying a proton by dissociation, the first carbon material having a larger center particle diameter than the second carbon material; and allowing the surface of the first carbon material to adsorb the second carbon material.

### BRIEF DESCRIPTION OF THE DRAWINGS

FIGS. 1A and 1B are schematic views for illustrating a supported catalyst according to a first embodiment of the invention;

FIGS. 2A and 2B are schematic views for illustrating a supported catalyst according to a second embodiment of the invention;

FIG. 3 is a flow chart for illustrating a method for manufacturing a supported catalyst according to the embodiment of the invention;

FIG. 4 is a schematic view for illustrating a fuel cell according to the embodiment of the invention; and

FIG. 5 is a flow chart for illustrating a method for manufacturing a fuel cell according to the embodiment of the invention.

### DETAILED DESCRIPTION OF THE INVENTION

Embodiments of the invention will now be illustrated with reference to the drawings.

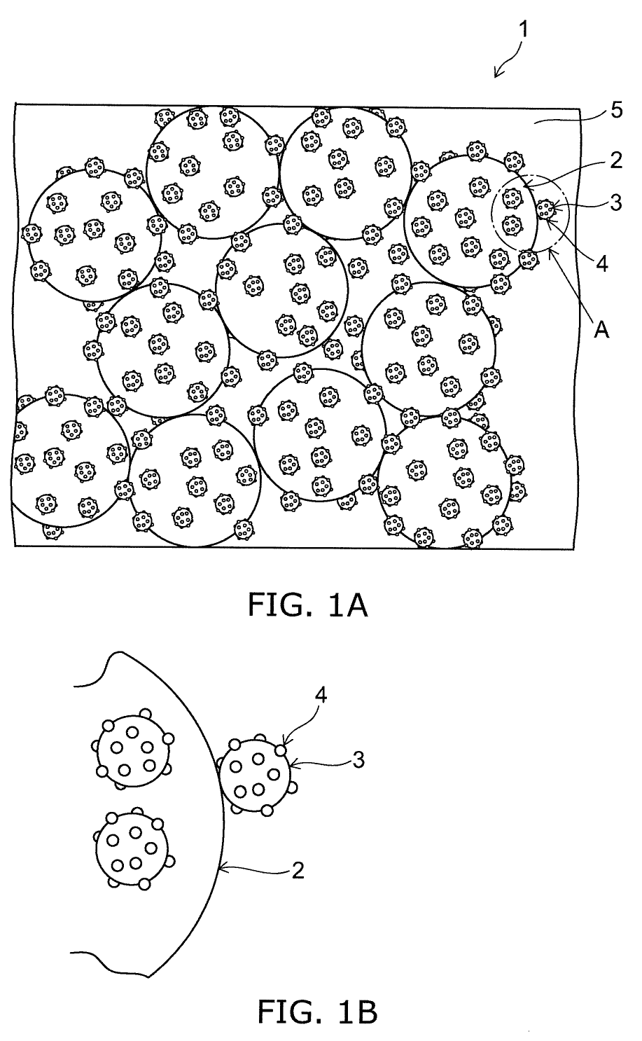

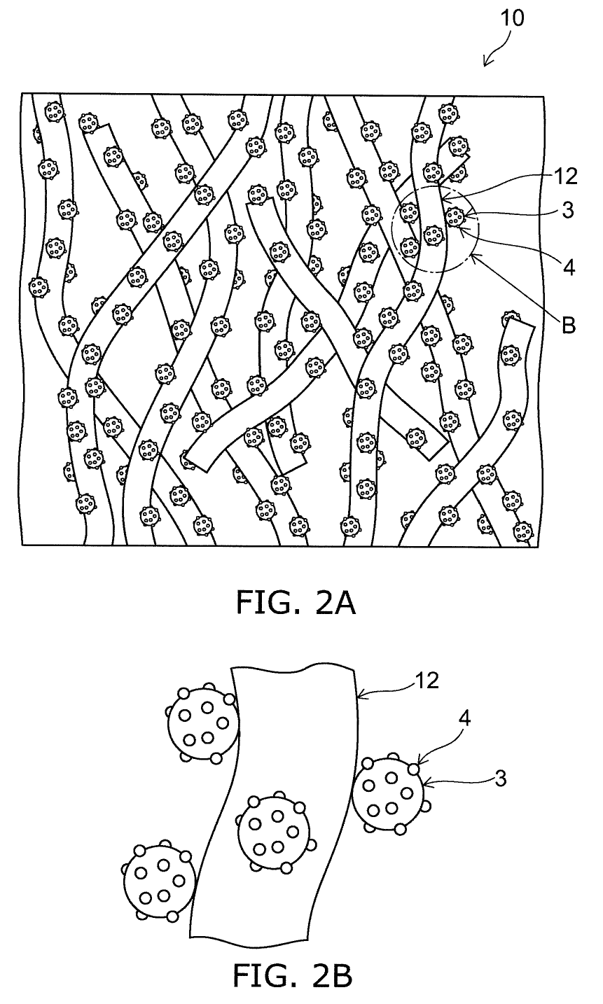

FIG. 1 is a schematic view for illustrating a supported catalyst according to a first embodiment of the invention.

Here, FIG. 1A is a schematic cross-sectional view of the supported catalyst, and FIG. 1B is a schematic partial enlarged view of portion A in FIG. 1A.

As shown in FIGS. 1A and 1B, the supported catalyst 1 (catalyst layer) includes a catalyst 4, a small-particle-diameter carbon material or carbon body (second carbon material) 3 supporting the catalyst 4, a large-particle-diameter carbon material or carbon body (first carbon material) 2 having a larger size than the carbon material 3, and a binder 5 filling the interstices therebetween. The small-particle-diameter carbon material 3 is in contact with the surface of the large-particle-diameter carbon material 2.

The large-particle-diameter carbon material 2 and the small-particle-diameter carbon material 3 can be made of a particulate carbon-based material, and can illustratively be a carbon black such as channel black, furnace black, lamp black, thermal black, and acetylene black (carbon fine particles industrially manufactured under quality control). It is noted that carbon blacks are not limited to the foregoing, but can be suitably changed.

In the case where the supported catalyst 1 is a supported catalyst on the fuel electrode side, the catalyst 4 only needs to be able to oxidize an organic fuel, and can illustratively include a solid solution of platinum with at least one metal selected from the group consisting of iron, nickel, cobalt, tin, ruthenium, and gold.

In the case where the supported catalyst 1 is a supported catalyst on the air electrode side, the catalyst 4 only needs to cause a reduction reaction, and can illustratively include a platinum-group element. For example, it can include an elemental metal such as platinum, ruthenium, rhodium, iridium, osmium, and palladium, and a solid solution containing a platinum-group element. The solid solution containing a platinum-group element can illustratively be a platinum-nickel solid solution. However, the invention is not limited thereto, but the material can be suitably modified.

The binder 5 can be primarily composed of a proton conductive material, and can illustratively be a fluorine-based resin having a sulfonic acid group (e.g., a perfluorosulfonic acid polymer) or a hydrocarbon-based resin having a sulfonic acid group. However, the invention is not limited thereto, but the material can be suitably modified.

Here, the power generation efficiency can be improved by increasing the amount of catalyst contained in the supported catalyst. The amount of catalyst can be increased by increasing the surface area of the carbon material (support) supporting the catalyst, and it can be achieved by minimizing the size of the carbon material.

However, if the size of the carbon material is decreased so that the supported catalyst is composed of only small carbon bodies, the number of carbon bodies failing to be in contact with other carbon bodies and isolated in the supported catalyst increases. In this case, the isolated carbon material cannot contribute to the passage of electrons (e⁻). Hence, the catalyst supported on the isolated carbon material cannot serve its function and is wasted.

As a result of study, the inventors have found that the number of small carbon bodies isolated in the supported catalyst can be reduced by providing a carbon material having a large size and a small carbon material in contact with its surface. If the number of small carbon bodies isolated in the supported catalyst can be reduced, electrons (e⁻) can be passed also in the vicinity of the catalyst supported thereon. Thus, the utilization efficiency of the catalyst, and hence the amount and efficiency of power generation, can be improved.

In this embodiment, the supported catalyst 1 includes a large-particle-diameter carbon material 2 and a small-particle-diameter carbon material 3 in contact with the surface of the large-particle-diameter carbon material 2. In this case, the carbon bodies 2 are provided adjacent to each other because they have a large size. Thus, at least some of the carbon bodies 2 are in contact with each other at a portion of the outer peripheral surfaces thereof. In fact, typically, most of the carbon bodies 2 are in contact with each other at a portion of the outer peripheral surfaces thereof. Hence, the number of carbon bodies isolated in the supported catalyst can be significantly reduced.

Because the small-particle-diameter carbon material 3 supporting the catalyst 4 is in contact with the surface of the large-particle-diameter carbon material 2, electrons (e⁻) can be reliably passed in the vicinity of the catalyst 4 through the large-particle-diameter carbon material 2 and the small-particle-diameter carbon material 3.

Thus, because the amount of wasted catalyst 4 can be reduced, the utilization efficiency of the catalyst 4, and hence the power generation efficiency, can be improved. Furthermore, by providing the small-particle-diameter carbon material 3, the area (surface area) of supporting the catalyst 4 can be extended, and the amount of catalyst 4 can be increased by that amount.

Furthermore, the inventors have found that more preferable utilization efficiency of the catalyst 4 and power generation efficiency can be achieved if the large-particle-diameter carbon material 2 has a center particle diameter of 1 micrometer or more and 10 micrometers or less and the small-particle-diameter carbon material 3 has a center particle diameter of 100 nanometers or less.

In the supported catalyst 1, electrons (e⁻) are conducted in the large-particle-diameter carbon material 2 and the small-particle-diameter carbon material 3 which are made of conductive materials. On the other hand, protons (H⁺) are conducted in the binder 5 primarily composed of a proton conductive material. Hence, the amount of binder 5 affects the conductivity of protons (H⁺).

Thus, if the amount of carbon material, particularly the amount of large-particle-diameter carbon material 2, contained in the supported catalyst 1 is increased, the amount of binder 5 decreases by that amount, and hence the proton conductivity may decrease.

As a result of further study, the inventors have found that if protons (H⁺) can be conducted by modifying the surface of the large-particle-diameter carbon material 2, it is possible to improve the proton conductivity, which might be otherwise decreased, by increasing the amount of large-particle-diameter carbon material 2.

Surface modification of the large-particle-diameter carbon material 2 can be realized by modifying the surface of the carbon material 2 with a substituent group capable of supplying protons by dissociation. Such surface modification illustratively includes sulfonization of the surface of the carbon material 2. Furthermore, for example, at least one substituent group selected from the group consisting of a carboxyl group, a sulfonyl group, an amino group, a nitro group, and a sulfo group can be provided directly, or via an organic structure, on the surface of the carbon material 2.

For example, the following chemical formula 1 represents the case of providing a sulfo group directly on the surface, and chemical formula 2 represents the case of providing a sulfo group on the surface via an organic structure.

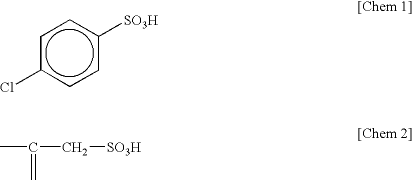

Furthermore, if the surface of the small-particle-diameter carbon material 3 is also modified to conduct protons (H⁺), proton conduction in the vicinity of the catalyst 4 can be performed more reliably.

Surface modification of the small-particle-diameter carbon material 3 can be realized by modifying the surface of the carbon material 3 with a substituent group capable of supplying protons by dissociation. Such surface modification illustratively includes sulfonization of the surface of the carbon material 3. Furthermore, for example, at least one substituent group selected from the group consisting of a carboxyl group, a sulfonyl group, an amino group, a nitro group, and a sulfo group can be provided directly, or via an organic structure, on the surface of the carbon material 3.

For example, the above chemical formula 1 represents the case of providing a sulfo group directly on the surface, and chemical formula 2 represents the case of providing a sulfo group on the surface via an organic structure.

As described above, according to this embodiment, the conduction path of electrons (e⁻) to the catalyst 4 can be efficiently formed. Furthermore, by surface modification of the carbon material, the conduction path of protons (H⁺) can be efficiently formed. Hence, the utilization efficiency of the catalyst 4 can be improved, and stable power generation at high output can be realized.

Furthermore, because the conduction path of protons (H⁺) is formed by surface modification of the carbon material, the effect of expansion and shrinkage of the binder 5 is insignificant. Hence, it is possible to provide stable power generation being resistant to changes in temperature and other external environment and having little temporal variation.

This embodiment has been described in the case of including carbon materials having two sizes (two center particle diameters), but is not limited thereto. It is also possible to include carbon materials having three or more sizes (three or more center particle diameters).

FIG. 2 is a schematic view for illustrating a supported catalyst according to a second embodiment of the invention.

Here, FIG. 2A is a schematic cross-sectional view of the supported catalyst, and FIG. 2B is a schematic partial enlarged view of portion B in FIG. 2A. The same portions as those described with reference to FIG. 1 are labeled with like reference numerals, and the description thereof is omitted.

As shown in FIGS. 2A and 2B, the supported catalyst 10 (catalyst layer) includes a catalyst 4, a small-particle-diameter carbon material or carbon body (second carbon material) 3 supporting the catalyst 4, an ultrafine fibrous carbon material or carbon body (first carbon material) 12 having a larger size than the carbon material 3, and a binder 5 filling the interstices therebetween. The small-particle-diameter carbon material 3 is in contact with the surface of the ultrafine fibrous carbon material 12.

The ultrafine fibrous carbon material 12 can illustratively be a carbon nanotube, a carbon nanofiber, a graphite nanofiber, a tubular graphite, a carbon nanocone with a sharp tip, and a conical graphite. It is noted that FIG. 2 shows the case where the carbon material 12 is a carbon nanotube. The ultrafine fibrous carbon material is not limited to the foregoing, but can be suitably changed.

In this embodiment, the supported catalyst 10 includes an ultrafine fibrous carbon material 12 and a small-particle-diameter carbon material 3 in contact with the surface of the carbon material 12. In this case, because the ultrafine fibrous carbon material 12 can be longitudinally elongated, it can be provided so as to connect between the end faces of the supported catalyst 10. Hence, migration of electrons (e⁻) between the inside and the end face of the supported catalyst 10 can be performed more reliably.

Furthermore, even if there is any carbon body 12 that is not connected to the end face of the supported catalyst 10, it is in contact with another carbon body 12 at a portion on its outer surface. That is, at least some of the carbon bodies 12 are in contact with each other at a portion of the outer surfaces thereof. Hence, the number of carbon bodies isolated in the supported catalyst 10 can be significantly reduced.

Because the small-particle-diameter carbon material 3 supporting the catalyst 4 is in contact with the surface of the carbon material 12, electrons (e⁻) can be passed in the vicinity of the catalyst 4 through the carbon material 12 and the carbon material 3. Thus, because the amount of wasted catalyst 4 can be reduced, the utilization efficiency of the catalyst 4, and hence the power generation efficiency, can be improved. Furthermore, by providing the small-particle-diameter carbon material 3, the area (surface area) of supporting the catalyst 4 can be extended, and the amount of catalyst 4 can be increased by that amount.

Furthermore, the inventors have found that more preferable utilization efficiency of the catalyst 4 and power generation efficiency can be achieved if the carbon material 12 has a center diameter of 1 micrometer or more and 10 micrometers or less and the small-particle-diameter carbon material 3 has a center particle diameter of 100 nanometers or less.

In the supported catalyst 10, electrons (e⁻) are conducted in the carbon material 12 and the carbon material 3 which are made of conductive materials. On the other hand, protons (H⁺) are conducted in the binder 5 primarily composed of a proton conductive material. Hence, the amount of binder 5 affects the conductivity of protons (H⁺).

Thus, if the amount of carbon material, particularly the amount of carbon material 12, contained in the supported catalyst 10 is increased, the amount of binder 5 decreases by that amount, and hence the proton conductivity may decrease.

As a result of further study, the inventors have found that if protons (H⁺) can be conducted by modifying the surface of the ultrafine fibrous carbon material 12, it is possible to improve the proton conductivity, which might be otherwise decreased, by increasing the amount of carbon material 12.

Surface modification of the carbon material 12 can be realized by modifying the surface of the carbon material 12 with a substituent group capable of supplying protons by dissociation. Such surface modification illustratively includes sulfonization of the surface of the carbon material 12. Furthermore, for example, at least one substituent group selected from the group consisting of a carboxyl group, a sulfonyl group, an amino group, a nitro group, and a sulfo group can be provided directly, or via an organic structure, on the surface of the carbon material 12. For example, the above chemical formula 1 represents the case of providing a sulfo group directly on the surface, and chemical formula 2 represents the case of providing a sulfo group on the surface via an organic structure.

Furthermore, if the surface of the small-particle-diameter carbon material 3 is also modified to conduct protons (H⁺), protons (H⁺) can be conducted more reliably to the vicinity of the catalyst 4.

Surface modification of the small-particle-diameter carbon material 3 is similar to that described above, and hence the description thereof is omitted.

As described above, according to this embodiment, the conduction path of electrons (e⁻) to the catalyst 4 can be formed more efficiently. Furthermore, by surface modification of the carbon material, the conduction path of protons (H⁺) can be efficiently formed. Hence, the utilization efficiency of the catalyst 4 can be improved, and stable power generation at high output can be realized.

Furthermore, because the conduction path of protons (H⁺) is formed by surface modification of the carbon material, the effect of expansion and shrinkage of the binder 5 is insignificant. Hence, it is possible to provide stable power generation being resistant to changes in temperature and other external environment and having little temporal variation.

This embodiment has been described in the case of including the small-particle-diameter carbon material 3, but is not limited thereto. It is also possible to include an ultrafine fibrous carbon material having a small diameter and a short length in place of or in addition to the small-particle-diameter carbon material 3 so as to be in contact with the large-particle-diameter carbon material 2 or carbon material 12 and support the catalyst 4.

Next, a method for manufacturing a supported catalyst according to an embodiment of the invention is illustrated.

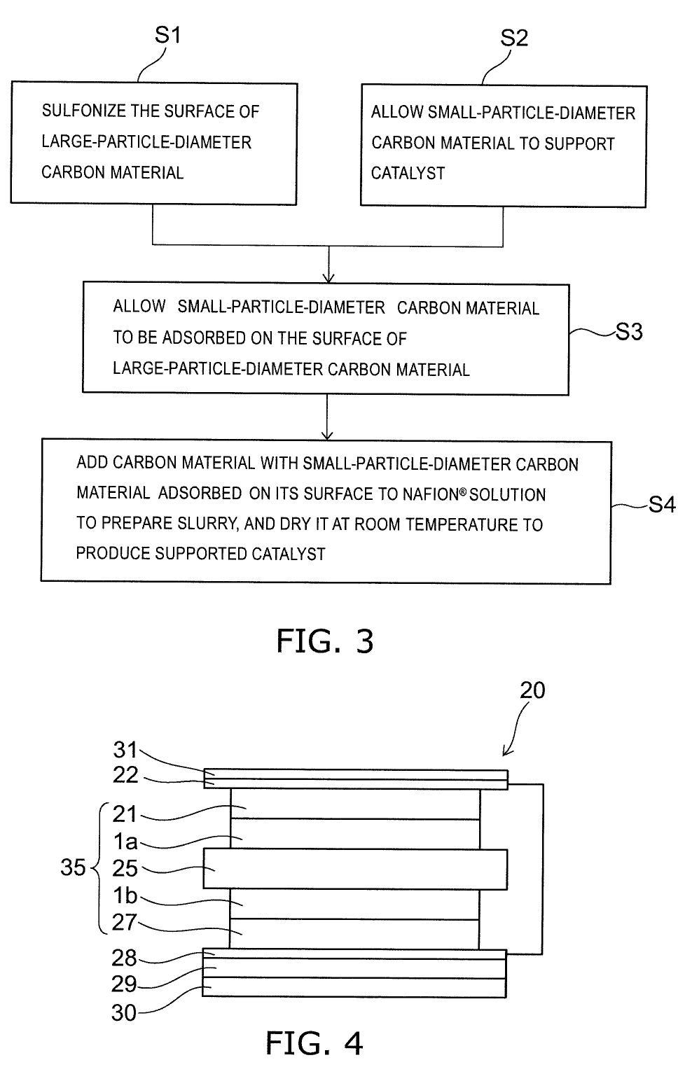

FIG. 3 is a flow chart for illustrating a method for manufacturing a supported catalyst according to the embodiment of the invention.

For convenience of description, modification of the surface of the carbon material with a substituent group capable of supplying protons by dissociation is exemplified by sulfonization of the surface of the carbon material. Furthermore, the following description illustrates the case of the supported catalyst 1 including a small-particle-diameter carbon material 3 supporting the catalyst and a large-particle-diameter carbon material 2 having a sulfonized surface.

First, the surface of the large-particle-diameter carbon material 2 is sulfonized (step S1).

The carbon material 2 itself can be a commercially available carbon black.

The surface of the carbon material 2 can be sulfonized illustratively by the following methods.

Firstly, the surface of the carbon material 2 can be directly sulfonized by using fuming sulfuric acid. In this method, first, a carbon black having a prescribed center particle diameter is immersed and stirred in an oil bath at 120° C. under a nitrogen atmosphere. Next, 30% fuming sulfuric acid is dropped thereto, and the reaction is continued for approximately 6 hours. Then, the mixture is left standing to cool to room temperature. The reaction liquid is poured into purified water, and the precipitate is filtered. It is washed with purified water until pH reaches approximately 5 to 6, and vacuum-dried under an atmosphere at 60° C. Thus, a carbon material 2 having a sulfonized surface can be obtained. Alternatively, the temperature of the oil bath can be 140° C., and the time of reaction with 30% fuming sulfuric acid can be approximately 48 hours.

Secondly, the surface of the carbon material 2 can be directly sulfonized by using sodium sulfite. In this method, first, a carbon black having a prescribed center particle diameter, sodium sulfite, and dimethylacetamide are immersed and stirred in an oil bath at 120° C. under a nitrogen atmosphere, and the reaction is continued for approximately 72 hours. Next, the reaction liquid is poured into diethyl ether and precipitated. The produced precipitate is washed with ethanol and vacuum-dried under an atmosphere at 60° C. Thus, a carbon material 2 having a sulfonized surface can be obtained.

Thirdly, the surface of the carbon material 2 can be sulfonized via an organic structure by using a sulfonized monomer (sulfonized 4,4′-difluorobenzophenone). In this method, first, a carbon black having a prescribed center particle diameter, sulfonized 4,4′-difluorobenzophenone, potassium carbonate, and a solvent (dimethylacetamide, toluene) are stirred under a nitrogen atmosphere at room temperature for approximately 1 hour. Next, it is immersed and stirred in an oil bath at 150° C., and the reaction is continued for approximately 3 hours. Then, it is returned to room temperature, and added with 18-crown-6. Next, it is immersed again in an oil bath at 160° C., and the reaction is continued for approximately 72 hours. This reaction product is reprecipitated in acetone, washed with purified water, and then vacuum-dried under an atmosphere at 80° C. Thus, a carbon material 2 having a surface sulfonized via an organic structure can be obtained.

Here, a method for producing sulfonized 4,4′-difluorobenzophenone is illustrated. 4,4′-difluorobenzophenone is immersed in an oil bath at 160° C. under a nitrogen atmosphere to melt the monomer. Then, the temperature of the oil bath is decreased to 120° C., and the oil bath is stirred. Next, 30% fuming sulfuric acid is dropped thereto for approximately 30 minutes, and the reaction is continued for approximately 6 hours. Then, the mixture is left standing to cool to room temperature. The reaction liquid is poured into saturated saline, and a precipitate is obtained by salting out and filtration. Next, this precipitate is dissolved into water and adjusted so that pH is approximately 8. Then, it is poured again into saturated saline for salting out. The crude sulfonized product thus obtained is recrystallized in a solution of 2-propanol/water=70/30 (weight %). This recrystallization is repeated three times, and the product is vacuum-dried under an atmosphere at 60° C. Thus, sulfonized 4,4′-difluorobenzophenone can be obtained.

It is noted that the method for sulfonization is not limited to the foregoing, but can be suitably changed.

On the other hand, the small-particle-diameter carbon material 3 is allowed to support the catalyst 4 (step S2).

To allow the carbon material 3 to support the catalyst 4, for example, platinum salt or ruthenium salt is added to a liquid dispersed with carbon black, reduced using hydrazine or the like, and filtered and dried.

For example, in the case where platinum (a catalyst on the air electrode side) is supported, first, carbon black is mixed with pure water to prepare a dispersion liquid. This dispersion liquid is added with a chloroplatinic acid solution and warmed to 60° C. Then, a hydrazine solution is dropped thereto to reduce chloroplatinic acid, and the product is filtered, washed, and dried. Thus, a carbon material 3 supporting platinum can be obtained.

A platinum-ruthenium solid solution (a catalyst on the fuel electrode side) can be supported similarly. For example, a chloroplatinic acid solution and ruthenium chloride are added to a liquid dispersed with carbon black, reduced by dropping thereto a hydrazine solution, and filtered and dried.

Next, the surface of the large-particle-diameter carbon material 2 is allowed to adsorb the small-particle-diameter carbon material 3 (step S3).

If the large-particle-diameter carbon material 2 having a sulfonized surface and the small-particle-diameter carbon material 3 supporting the catalyst 4 are mixed in pure water and irradiated with a 28-kHz supersonic wave for 5 minutes, then the small-particle-diameter carbon material 3 can be dispersed and adsorbed on the surface of the large-particle-diameter carbon material 2.

Next, the carbon material 2 with the carbon material 3 adsorbed on its surface is added to a solution of Nafion® (available from DuPont) and mixed in a homogenizer to prepare a slurry. The supported catalyst 1 is obtained by drying this slurry at room temperature (step S4).

In this case, Nafion® (from DuPont) in the slurry serves as a binder 5. It is also possible to apply this slurry to a carbon paper serving as a gas diffusion layer, described below, and dry it at room temperature.

In the case of the ultrafine fibrous carbon material, the carbon black described above can be replaced by a carbon nanotube, a carbon nanofiber, a graphite nanofiber, a tubular graphite, a carbon nanocone with a sharp tip, or a conical graphite.

Furthermore, the surface of the small-particle-diameter carbon material 3 can also be sulfonized likewise. In this case, the catalyst 4 can be supported on the carbon material 3 having a sulfonized surface, or the surface of the carbon material 3 supporting the catalyst 4 can be sulfonized.

Next, a fuel cell provided with the supported catalyst according to this embodiment is illustrated.

FIG. 4 is a schematic view for illustrating a fuel cell according to the embodiment of the invention.

For convenience of description, a direct methanol fuel cell (DMFC), which uses methanol as a fuel, is taken as an example.

As shown in FIG. 4, the fuel cell 20 has a membrane electrode assembly (MEA) 35 as an electromotive section. The membrane electrode assembly 35 includes a fuel electrode composed of a supported catalyst 1b (a catalyst layer on the fuel electrode side) according to this embodiment and a gas diffusion layer 27, an air electrode composed of a supported catalyst 1a (a catalyst layer on the air electrode side) according to this embodiment and a gas diffusion layer 21, and a polymer solid electrolyte membrane 25 held between the supported catalyst 1b of the fuel electrode and the supported catalyst 1a of the air electrode.

The supported catalyst 1a and the supported catalyst 1b can illustratively be the supported catalyst 1 or the supported catalyst 10 described above. It is also possible to use the supported catalyst according to this embodiment for at least one of the supported catalyst of the fuel electrode and the supported catalyst of the air electrode. However, the cell characteristics can be further improved by using the supported catalyst according to this embodiment for both of them.

The catalyst 4 of the supported catalyst 1b only needs to be able to oxidize an organic fuel, and can illustratively include fine particles made of a solid solution of platinum with at least one metal selected from the group consisting of iron, nickel, cobalt, tin, ruthenium, and gold.

The catalyst 4 of the supported catalyst 1a only needs to cause a reduction reaction, and can illustratively include a platinum-group element. For example, it can include an elemental metal such as platinum, ruthenium, rhodium, iridium, osmium, and palladium, and a solid solution containing a platinum-group element. The solid solution containing a platinum-group element can illustratively be a platinum-nickel solid solution.

However, the invention is not limited thereto, but the material can be suitably modified.

The polymer solid electrolyte membrane 25 can be primarily composed of a proton conductive material, and can illustratively be a fluorine-based resin having a sulfonic acid group (e.g., a perfluorosulfonic acid polymer) or a hydrocarbon-based resin having a sulfonic acid group. However, the invention is not limited thereto, but the material can be suitably modified.

Here, the polymer solid electrolyte membrane 25 can be a membrane made of a porous material having through holes or a membrane made of an inorganic material having openings, in which the through holes or openings are filled with a polymer solid electrolyte material, or can be a membrane made of a polymer solid electrolyte material.

The gas diffusion layer 27 provided on the surface of the supported catalyst 1b of the fuel electrode serves to uniformly supply fuel to the supported catalyst 1b.

The gas diffusion layer 21 provided on the surface of the supported catalyst 1a of the air electrode serves to uniformly supply oxygen to the supported catalyst 1a, and also serves to adjust the degree of permeation of water produced in the supported catalyst 1a (drainability and moisture retention).

A conductive layer 28 is laminated on the gas diffusion layer 27 of the fuel electrode, and a conductive layer 22 is laminated on the gas diffusion layer 21 of the air electrode. The conductive layer 28 and the conductive layer 22 can be illustratively made of a porous layer such as a mesh of gold or other conductive metal material, or a gold foil having a plurality of openings. The conductive layer 22 and the conductive layer 28 are electrically connected to each other through a load, not shown.

The conductive layer 28 on the fuel electrode side is connected to a liquid fuel tank 30 serving as a fuel supply section through a gas-liquid separation membrane 29. The gas-liquid separation membrane 29 serves as a vapor-phase fuel permeation membrane, which is only permeable to the vaporized component of liquid fuel and not permeable to the liquid fuel.

The gas-liquid separation membrane 29 is disposed so as to occlude the opening, not shown, provided to extract the vaporized component of liquid fuel in the liquid fuel tank 30. The gas-liquid separation membrane 29 separates the vaporized component of the fuel from the liquid fuel and further vaporizes the liquid fuel, and can be illustratively made of silicone rubber or other material.

Further on the liquid fuel tank 30 side of the gas-liquid separation membrane 29, it is possible to provide a permeability adjusting membrane, not shown, having a gas-liquid separation function like the gas-liquid separation membrane 29 and adjusting the permeated amount of the vaporized component of fuel. The permeated amount of the vaporized component through this permeability adjusting membrane is adjusted by varying the opening ratio of the permeability adjusting membrane. This permeability adjusting membrane can be illustratively made of polyethylene terephthalate or other material. Such a permeability adjusting membrane allows gas-liquid separation of fuel and adjustment of the amount of the vaporized component of fuel supplied to the supported catalyst 1b side of the fuel electrode.

The liquid fuel stored in the liquid fuel tank 30 can be a methanol aqueous solution having a concentration exceeding 50 mole % or pure methanol. The purity of pure methanol can be 95 weight % or more and 100 weight % or less. The vaporized component of liquid fuel illustratively refers to vaporized methanol in the case of using pure methanol as the liquid fuel, and to an air-fuel mixture of the vaporized component of methanol and the vaporized component of water in the case of using a methanol aqueous solution as the liquid fuel.

On the other hand, a cover 31 is laminated to the conductive layer 22 of the air electrode. The cover 31 is provided with a plurality of air inlets, not shown, for taking in air (oxygen) as an oxidizer. The cover 31 also serves to pressurize the membrane electrode assembly 35 to enhance adhesion therein, and hence can be illustratively made of metal such as SUS304.

Next, the function of the fuel cell 20 according to this embodiment is illustrated.

The methanol aqueous solution (liquid fuel) in the liquid fuel tank 30 is vaporized to generate an air-fuel mixture of vaporized methanol and steam, which permeates the gas-liquid separation membrane 29. Then, the air-fuel mixture further passes through the conductive layer 28, is diffused in the gas diffusion layer 27, and is supplied to the supported catalyst 1b. The air-fuel mixture supplied to the supported catalyst 1b undergoes the oxidation reaction given by the following formula (1):

CH₃OH+H₂O→CO₂+6H⁺+6e⁻ (1)

In the case of using pure methanol as the liquid fuel, no steam is supplied from the liquid fuel tank 30. Hence, the oxidation reaction of the above formula (1) is caused by methanol with the water generated in the supported catalyst 1a of the air electrode, described below, and the water in the polymer solid electrolyte membrane 25.

Protons (H⁺) produced by the oxidation reaction of the above formula (1) are conducted in the polymer solid electrolyte membrane 25 and reach the supported catalyst 1a of the air electrode. Electrons (e⁻) produced by the oxidation reaction of the above formula (1) are supplied from the conductive layer 28 to a load, not shown, do work therein, and then reach the supported catalyst 1a through the conductive layer 22 and the gas diffusion layer 21.

On the other hand, air (oxygen) taken in through the air inlets, not shown, of the cover 31 permeates the conductive layer 22, is diffused in the gas diffusion layer 21, and is supplied to the supported catalyst 1a. Oxygen in the air supplied to the supported catalyst 1a reacts with protons (H⁺) and electrons (e⁻), which have reached the supported catalyst 1a, by the following formula (2) to produce water:

$$\frac{3}{2} {O}_{2} + 6 {H}^{+} + 6 {e}^{-} \to 3 {H}_{2} O \qquad ( 2 )$$

Part of the water generated in the supported catalyst 1a of the air electrode by this reaction permeates the gas diffusion layer 21 to reach vapor-liquid equilibrium inside the gas diffusion layer 21. Vaporized water is evaporated from the air inlets, not shown, of the cover 31. Water in liquid form is stored in the supported catalyst 1a of the air electrode.

As the reaction of formula (2) proceeds, the amount of produced water increases, and the amount of moisture stored in the supported catalyst 1a of the air electrode increases. Then, with the progress of the reaction of formula (2), the amount of moisture stored in the supported catalyst 1a of the air electrode becomes larger than the amount of moisture stored in the supported catalyst 1b of the fuel electrode.

Consequently, the water produced in the supported catalyst 1a of the air electrode migrates by osmosis through the polymer solid electrolyte membrane 25 to the supported catalyst 1b of the fuel electrode. Hence, as compared with the case where the supply of moisture to the supported catalyst 1b of the fuel electrode relies only on steam vaporized from the liquid fuel tank 30, the supply of moisture is facilitated, and the reaction of the above formula (1) can be accelerated. Thus, the output density can be increased, and the increased output density can be maintained for a long period of time.

More specifically, even in the case where a methanol aqueous solution having a methanol concentration exceeding 50 mole % or pure methanol is used as a liquid fuel, the water which has migrated from the supported catalyst 1a of the air electrode to the supported catalyst 1b of the fuel electrode can be used for the reaction of the above formula (1). Furthermore, reaction resistance to the reaction of the above formula (1) can be further reduced to improve long-term output characteristics and load current characteristics. Moreover, the liquid fuel tank 30 can be downsized. Furthermore, high proton (H⁺) conductivity can be achieved because the polymer solid electrolyte membrane 25 can be moistened.

According to this embodiment, the conduction path of electrons (e⁻) to the catalyst 4 can be efficiently formed. Furthermore, by surface modification of the carbon material, the conduction path of protons (H⁺) can be efficiently formed. Hence, the utilization efficiency of the catalyst 4 can be improved, and the reactions of the above formulas (1) and (2) can be performed efficiently and stably.

Furthermore, because the conduction path of protons (H⁺) is formed by surface modification of the carbon material, the effect of expansion and shrinkage of the binder 5 is insignificant. Hence, it is possible to provide stable power generation being resistant to changes in temperature and other external environment and having little temporal variation.

The liquid fuel tank 30 of this fuel cell 20 was injected with 5 milliliters of pure methanol (95 weight % or more), and the maximum output was measured from the current and voltage value in an environment at a temperature of 25° C. and a relative humidity of 50%. Furthermore, the maximum surface temperature was measured by a thermocouple attached to the surface of the fuel cell. The supported catalyst was the supported catalyst 1 described above.

As a result of this measurement, the maximum output was 22.2 mW/cm², and the maximum surface temperature of the fuel cell was 33.4° C.

A similar measurement was made on a fuel cell provided with a supported catalyst composed only of a carbon material having a prescribed average particle diameter. The maximum output in this measurement was 20.1 mW/cm². Thus, it was confirmed that the supported catalyst according to this embodiment can increase the maximum output by approximately 10%.

Furthermore, a 500-hour endurance test was also performed. As a result, the output variation was within 12% for the fuel cell provided with the supported catalyst according to this embodiment, whereas the output variation was 23% for the fuel cell provided with a supported catalyst composed only of a carbon material having a prescribed average particle diameter. Thus, the superiority of this embodiment was confirmed also in durability.

Next, a method for manufacturing the fuel cell 20 according to this embodiment is illustrated.

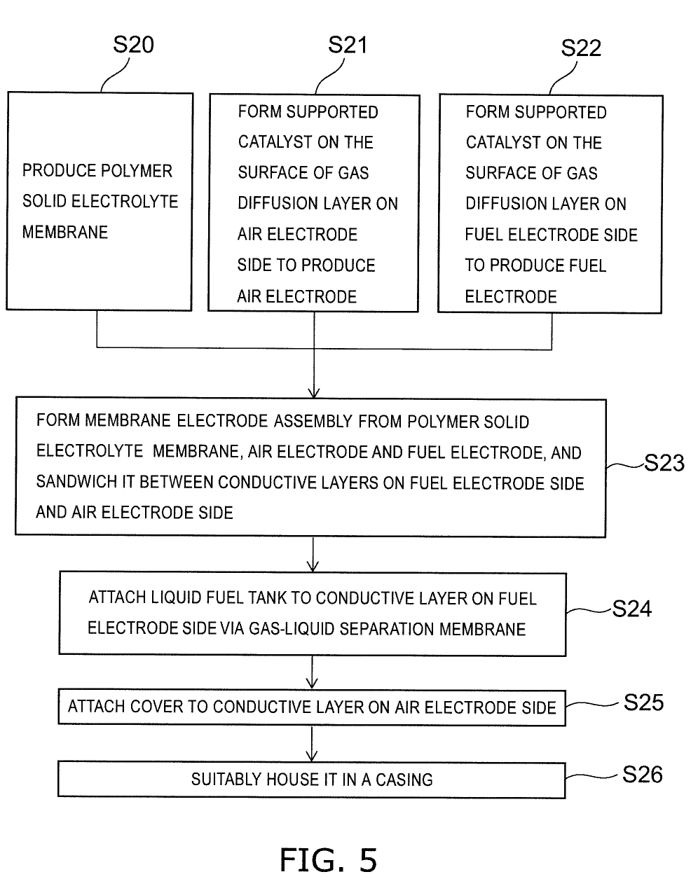

FIG. 5 is a flow chart for illustrating a method for manufacturing a fuel cell according to the embodiment of the invention.

First, a porous material membrane is produced using chemical or physical methods such as the phase separation method, the foaming method, and the sol-gel method. The porous material membrane can be suitably based on commercially available porous materials. For example, a polyimide porous membrane having a thickness of 25 μm and an opening ratio of 45% (UPILEX-PT™, manufactured by Ube Industries, Ltd.) can be used.

A polymer solid electrolyte is filled in this porous material membrane to produce a polymer solid electrolyte membrane 25 (step S20).

The method for filling the polymer solid electrolyte can illustratively include immersing the porous material membrane in an electrolyte solution, and pulling it up and drying it to remove the solvent. The electrolyte solution can illustratively be a Nafion® (manufactured by DuPont) solution. It is noted that the polymer solid electrolyte membrane 25 can be a membrane made of a polymer electrolyte material. In this case, there is no need to produce a porous material membrane and fill a polymer solid electrolyte therein.

Next, on the basis of the above-described method for manufacturing a supported catalyst according to this embodiment, a supported catalyst 1a is formed on the surface of the gas diffusion layer 21 on the air electrode side to produce an air electrode (step S21).

On the other hand, on the basis of the above-described method for manufacturing a supported catalyst according to this embodiment, a supported catalyst 1b is formed on the surface of the gas diffusion layer 27 on the fuel electrode side to produce a fuel electrode (step S22).

Here, it is also possible to use the supported catalyst according to this embodiment for at least one of the supported catalyst of the fuel electrode and the supported catalyst of the air electrode. However, the cell characteristics can be further improved by using the supported catalyst according to this embodiment for both of them.

Next, a membrane electrode assembly 35 is formed from the polymer solid electrolyte membrane 25, the air electrode (supported catalyst 1a and gas diffusion layer 21), and the fuel electrode (supported catalyst 1b and gas diffusion layer 27), and sandwiched between a conductive layer 28 and a conductive layer 22, which are illustratively made of gold foil having a plurality of openings for taking in vaporized methanol or air (step S23).

Next, a liquid fuel tank 30 is attached to the conductive layer 28 via a gas-liquid separation membrane 29 (step S24).

The gas-liquid separation membrane 29 can be illustratively made of a silicone sheet.

Next, a cover 31 is attached to the conductive layer 22 (step S25).

The cover 31 can be illustratively made of a stainless steel plate (SUS304), which has air inlets, not shown, for taking in air.

Finally, this is suitably housed in a casing to form a fuel cell 20 (step S26).

The embodiments of the invention have been illustrated. However, the invention is not limited to the above description.

The above embodiments can be suitably modified by those skilled in the art, and such modifications are also encompassed within the scope of the invention as long as they fall within the spirit of the invention.

For example, the shape, dimension, material, layout, and number of the elements included in the supported catalyst 1, the supported catalyst 10, and the fuel cell 20 described above are not limited to those illustrated, but can be suitably modified.

With regard to the fuel, a methanol aqueous solution is taken as an example. However, the fuel is not limited thereto. Besides methanol, other fuels can include alcohols such as ethanol and propanol, ethers such as dimethyl ether, cycloparaffins such as cyclohexane, and cycloparaffins having a hydrophilic group such as a hydroxy group, carboxyl group, amino group, and amido group. Such fuel is typically used as an aqueous solution with approximately 5 to 90 weight %.

The elements included in the above embodiments can be combined as long as feasible, and such combinations are also encompassed within the scope of the invention as long as they fall within the spirit of the invention.

1. A supported catalyst comprising:
a particulate first carbon material; and
a particulate second carbon material supporting a catalyst, having a smaller center particle diameter than the first carbon material, and adsorbed on a surface of the first carbon material.

2. The supported catalyst according to claim 1, wherein
the center particle diameter of the first carbon material is 1 micrometer or more and 10 micrometers or less, and
the center particle diameter of the second carbon material is 100 nanometers or less.

3. The supported catalyst according to claim 1, wherein the surface of the first carbon material is modified with a substituent group capable of supplying a proton by dissociation.

4. The supported catalyst according to claim 1, wherein the surface of the second carbon material is modified with a substituent group capable of supplying a proton by dissociation.

5. The supported catalyst according to claim 3, wherein the modification with the substituent group includes sulfonization.

6. The supported catalyst according to claim 4, wherein the modification with the substituent group includes sulfonization.

7. The supported catalyst according to claim 3, wherein the substituent group is at least one or more selected from the group consisting of a carboxyl group, a sulfonyl group, an amino group, a nitro group, and a sulfo group.

8. The supported catalyst according to claim 4, wherein the substituent group is at least one or more selected from the group consisting of a carboxyl group, a sulfonyl group, an amino group, a nitro group, and a sulfo group.

9. A supported catalyst comprising:
a linear first carbon material; and
a second carbon material supporting a catalyst and adsorbed on a surface of the first carbon material.

10. The supported catalyst according to claim 9, wherein the surface of the first carbon material is modified with a substituent group capable of supplying a proton by dissociation.

11. The supported catalyst according to claim 9, wherein the surface of the second carbon material is modified with a substituent group capable of supplying a proton by dissociation.

12. The supported catalyst according to claim 10, wherein the modification with the substituent group includes sulfonization.

13. The supported catalyst according to claim 11, wherein the modification with the substituent group includes sulfonization.

14. The supported catalyst according to claim 10, wherein the substituent group is at least one or more selected from the group consisting of a carboxyl group, a sulfonyl group, an amino group, a nitro group, and a sulfo group.

15. The supported catalyst according to claim 11, wherein the substituent group is at least one or more selected from the group consisting of a carboxyl group, a sulfonyl group, an amino group, a nitro group, and a sulfo group.

16. A method for manufacturing a supported catalyst, comprising:
allowing a particulate second carbon material to support a catalyst;
modifying a surface of a first carbon material with a substituent group capable of supplying a proton by dissociation, the first carbon material having a larger center particle diameter than the second carbon material; and
allowing the surface of the first carbon material to adsorb the second carbon material.

17. A method for manufacturing a supported catalyst, comprising:
allowing a second carbon material to support a catalyst;
modifying a surface of a linear first carbon material with a substituent group capable of supplying a proton by dissociation; and
allowing the surface of the first carbon material to adsorb the second carbon material.

18. The method for manufacturing a supported catalyst according to claim 17, further comprising:
modifying a surface of the second carbon material with a substituent group capable of supplying a proton by dissociation.

19. The method for manufacturing a supported catalyst according to claim 16, wherein the modification with the substituent group includes sulfonization.

20. The method for manufacturing a supported catalyst according to claim 17, wherein the modification with the substituent group includes sulfonization.

21. The method for manufacturing a supported catalyst according to claim 16, wherein the substituent group is at least one or more selected from the group consisting of a carboxyl group, a sulfonyl group, an amino group, a nitro group, and a sulfo group.

22. The method for manufacturing a supported catalyst according to claim 17, wherein the substituent group is at least one or more selected from the group consisting of a carboxyl group, a sulfonyl group, an amino group, a nitro group, and a sulfo group.

23. A fuel cell comprising:
a fuel electrode having a supported catalyst;
an air electrode having a supported catalyst; and
a polymer solid electrolyte membrane provided between the fuel electrode and the air electrode,
at least one of the supported catalysts of the fuel electrode and the air electrode is the supported catalyst including:
a particulate first carbon material; and
a particulate second carbon material supporting a catalyst, having a smaller center particle diameter than the first carbon material, and adsorbed on a surface of the first carbon material.

24. A fuel cell comprising:
a fuel electrode having a supported catalyst;
an air electrode having a supported catalyst; and
a polymer solid electrolyte membrane provided between the fuel electrode and the air electrode,
at least one of the supported catalysts of the fuel electrode and the air electrode is the supported catalyst including:
a linear first carbon material; and
a second carbon material supporting a catalyst and adsorbed on a surface of the first carbon material.

25. A method for manufacturing a fuel cell, the fuel cell including a fuel electrode having a supported catalyst, an air electrode having a supported catalyst, and a polymer solid electrolyte membrane provided between the fuel electrode and the air electrode, the method comprising:
manufacturing at least one of the supported catalysts of the fuel electrode and the air electrode by the method for manufacturing a supported catalyst including:
allowing a particulate second carbon material to support a catalyst;
modifying a surface of a first carbon material with a substituent group capable of supplying a proton by dissociation, the first carbon material having a larger center particle diameter than the second carbon material; and
allowing the surface of the first carbon material to adsorb the second carbon material.

26. A method for manufacturing a fuel cell, the fuel cell including a fuel electrode having a supported catalyst, an air electrode having a supported catalyst, and a polymer solid electrolyte membrane provided between the fuel electrode and the air electrode, the method including:
manufacturing at least one of the supported catalysts of the fuel electrode and the air electrode by the method for manufacturing a supported catalyst comprising:
allowing a second carbon material to support a catalyst;
modifying a surface of a linear first carbon material with a substituent group capable of supplying a proton by dissociation; and
allowing the surface of the first carbon material to adsorb the second carbon material.
